(19) United States
(12) Patent Application Publication
(10) Pub. No.: US 2009/0294681 A1
(43) Pub. Date: Dec. 3, 2009

(54) Radiation Detector with Dual-Speed Scintillator

(75) Inventor: William A. Worstell, Wayland, MA (US)

Correspondence Address: FISH & RICHARDSON PC, P.O. BOX 1022, MINNEAPOLIS, MN, 55440-1022, US

(73) Assignee: PHOTODETECTION SYSTEMS, INC., Boxborough, MA (US)

(21) Appl. No.: 12/019,427

(22) Filed: Jan. 24, 2008

Related U.S. Application Data
(60) Provisional application No. 60/886,409, filed on Jan. 24, 2007.

(51) Int. Cl. G01T 1/20; G01T 1/26

(52) U.S. Cl. 250/370.11; 250/371

(57) ABSTRACT

An apparatus for detecting radiation includes a dual-speed scintillator for receiving the radiation and emitting secondary radiation in response thereto, and detectors in communication with the dual-speed scintillator for receiving the secondary radiation.

### RELATED APPLICATIONS

Under 35 USC 119, this application claims the benefit of the priority date of U.S. Provisional Application 60/886,409, filed on Jan. 24, 2007, the contents of which are herein incorporated by reference.

### FIELD OF DISCLOSURE

This disclosure relates to radiation detectors, and in particular, to radiation detectors for use in PET scanners.

### BACKGROUND

In positron emission tomography (“PET”), a radioactive material is placed in the patient. In the process of radioactive decay, this material emits positrons. These positrons travel through the patient until they encounter electrons. When a positron and an electron meet, they annihilate each other. This results in emission of two gamma ray photons traveling in opposite directions. By detecting these gamma ray photons, one can infer the distribution of the radioactive material within the patient.

Certain materials, referred to as scintillating crystals, or “scintillators,” emit an isotropic spray of scintillation photons centered at a point at which a gamma ray interacts with the material. Some of these scintillation photons are emitted in a direction that takes them to a photodetector. Other scintillation photons, which are emitted in a direction away from any photodetector, nevertheless manage to reach a photodetector after being redirected by structures within the scintillating crystal. Yet other scintillation photons are absorbed and therefore never reach the photodetector at all.

To detect gamma ray photons, the patient is positioned within a ring of scintillating crystals. Photodetectors observing the crystals can then detect the scintillation photons and provide, to a processor, information on how many coincident gamma ray photon pairs were received in a particular interval and at what location those gamma ray photon pairs originated. The processor then processes such data arriving from all photodetectors to form an image showing the spatial distribution of radioactive material within the patient.

### SUMMARY

In one aspect, the invention features an apparatus for detecting radiation. The apparatus includes a dual-speed scintillator for receiving the radiation and emitting secondary radiation in response thereto, and detectors in communication with the dual-speed scintillator for receiving the secondary radiation.

Some embodiments include a processor in communication with the detectors. The processor is configured to generate an image in response to signals received from the detectors.

Other embodiments are those in which the dual-speed scintillator includes intrinsic cesium iodide. In some of these embodiments, the intrinsic cesium iodide has been heated and quenched to form lattice defects.

Yet other embodiments include those in which the dual-speed scintillator is doped. These embodiments include those having a scintillator with sodium-doped cesium iodide. Among these are embodiments in which the cesium iodide is doped with sodium at a concentration between 30 ppm and 200 ppm, and those in which the cesium iodide is doped with sodium at a concentration of about 100 ppm.

In some embodiments, the dual-speed scintillator includes thallium-doped cesium iodide. In others, the dual-speed scintillator includes cesium bromide.

In yet other embodiments, the dual-speed scintillator includes cesium iodide and cesium bromide. Among these are the embodiments in which the scintillator includes approximately 2% bromine and 98% iodine.

Other embodiments also include europium in the scintillator.

In another aspect, the invention features a method for detecting radiation. The method includes receiving first data representative of a slow component from a scintillator; receiving second data representative of a fast component from a scintillator; processing the first data to obtain an estimate of a first characteristic of an event within the scintillator; and processing the second data to obtain an estimate of a second characteristic of an event within the scintillator.

Some practices also include classifying the event as one event of a coincidence at least in part on the basis of the first and second data.

Other practices include those in which the first characteristic is selected to be an energy associated with the event, and those in which the second characteristic is selected to be a time of occurrence of the event.

Yet other practices include those that include estimation of a time-of-flight associated with photons emitted as a result of the event.

Other features and advantages of the invention will be apparent from the following detailed description and the accompanying figures, in which:

### BRIEF DESCRIPTION OF THE FIGURES

FIG. 1 shows a ring of modules;

FIGS. 2A and 2B show a detector block;

FIG. 3 shows the wavelength response of sodium-doped cesium iodide crystal at various dopant concentrations; and

FIG. 4 shows the temporal response of a dual-speed scintillation crystal.

### DETAILED DESCRIPTION

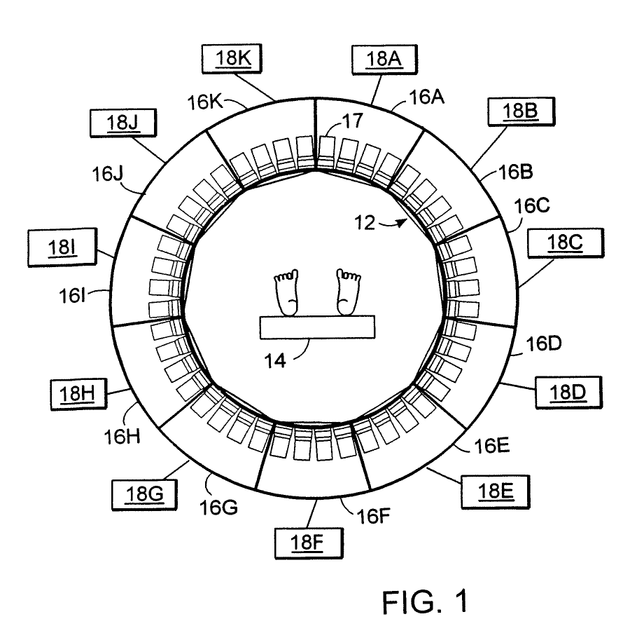

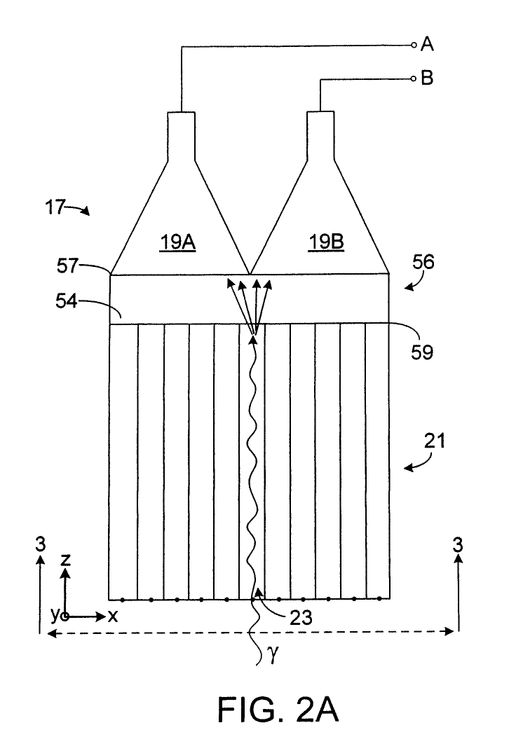

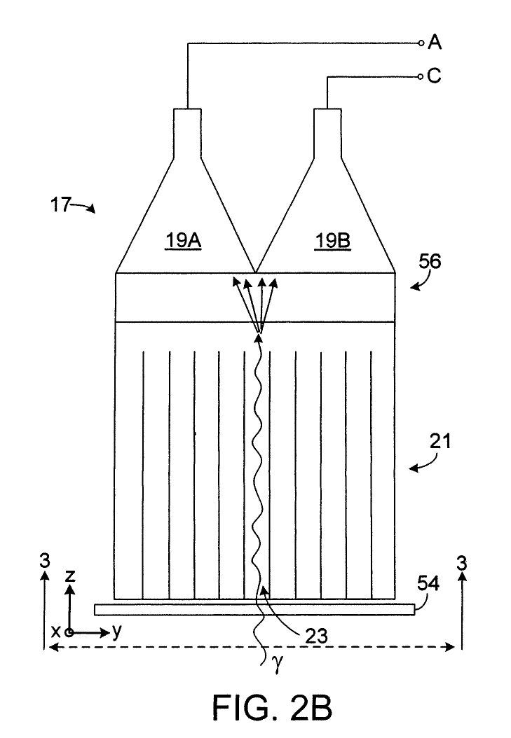

Referring to FIG. 1, a PET scanner 10 includes a ring 12 of detector modules 16A-K surrounding a bed 14 on which a patient is to lie. Each detector module 16A-K (hereinafter referred to as a “module”) includes one or more rows of detector blocks 17. A detector block 17, shown in FIG. 2A, includes, for example, four photomultiplier tubes 19A-D arranged in a 2×2 array in optical communication with a scintillator block 21. The scintillator block 21 is typically made of a dual-speed scintillation crystal.

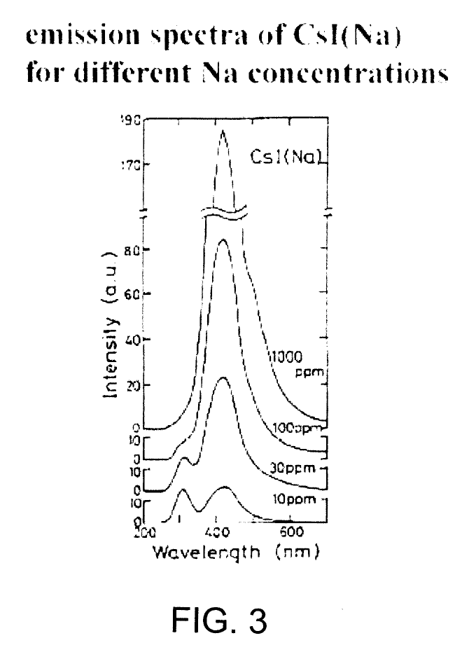

A common material for use in scintillation crystals is cesium iodide doped with either sodium or with thallium. FIG. 3 shows the response of a sodium-doped cesium iodide crystal to an event for various levels of dopant concentration, ranging from almost pure cesium iodide, with a dopant concentration of 10 ppm, to heavily doped cesium iodide, with a dopant concentration of 1000 ppm.

At low levels of dopant concentration, sodium-doped cesium iodide responds to a gamma ray photon by first emitting photons in the UV range. This is followed by an emission of additional photons in the visible range. The first set of photons, namely those in the UV range, form the “fast component” of the response. The second set of photons, namely those in the visible range, form the “slow component” of the response.

In sodium-doped cesium iodide, the response arising from the fast component (hereafter the “fast response”) begins approximately 10 ns after an event. This fast response is characterized by a rapid rise time and a rapid drop-off. As such, it is particularly useful for accurately determining when an event occurred. This is useful for determining whether two events form a coincidence.

In sodium-doped cesium iodide, the response arising from the slow component (hereafter the “slow response”) begins approximately 100 ns after the event. This slow component tends to have a slower rise time. Accordingly, the slow response is not as useful for accurately determining when an event has occurred. However, the slow response provides a great many photons over an extended interval. As a result, it is useful for determining the energy associated with an event.

Additional responses occur on the order of microseconds or milliseconds after the event. These responses contribute to what is referred to as the “afterglow.” The afterglow is analogous to the extended reverberations that one might hear after setting off an explosion in a cave. Such afterglow can be suppressed, to some extent, by further doping the scintillation crystal with europium.

It is apparent from FIG. 3 that for low levels of dopant concentration, there is a pronounced distinction between the fast component and the slow component. As the dopant concentration increases, the fast and slow components tend to overlap in wavelength, making them more difficult for a detecting system to distinguish.

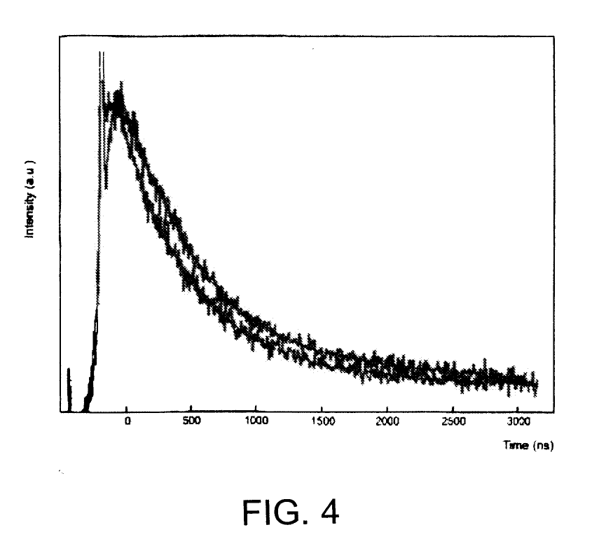

For PET scanners with lightly-doped scintillation crystals, there exist two distinct portions of the temporal response, as shown in FIG. 4. As discussed above, there is a fast response, which is a short-rise time pulse that arises from the fast component. This fast response is followed by the slow response, which is an extended pulse with a slower decay. A scintillation crystal in which one can use the fast response and the slow response separately to perform different functions shall be referred to as a “dual-speed” scintillation crystal.

A dual-speed scintillation crystal having the aforementioned properties can be obtained by doping cesium iodide with sodium at a concentration between 30 ppm and 200 ppm. A particularly useful dual-speed scintillation crystal is a sodium-doped cesium iodide crystal having a dopant concentration on the order of 100 ppm. This results in a response in which about 20% of the photons arise from the fast component and the remaining 80% from the slow component. This ratio of photons from the fast component to the total number of photons is preferably less than 50% and more than 5%.

However, one can use other dopants to form a dual-speed scintillation crystal having the desired properties. For example, one can form a crystal with a mixture of cesium iodide and cesium bromide, and then dope the resulting crystal with sodium. One such crystal would have 2% of the dopant atoms be bromine and the remainder sodium. Such a blend is believed to further enhance the fast wave component by increasing the total number of photons emitted and the number of photons emitted per nanosecond.

In some cases, one can form an intrinsic crystal having the desired properties. For example, pure cesium iodide can be heated, and then quenched. This will form crystal defects that serve essentially the same function as the sodium dopant. Such a crystal will, until such time as the crystal defects gradually disappear, function as a dual-speed scintillation crystal.

Photomultiplier tubes 19A-B are visible in FIG. 2A and photomultiplier tubes 19A-C are visible in FIG. 2B. The remaining photomultiplier tube 19D, which lies diagonally across the array from photomultiplier tube 19A is not visible.

In general, the photomultiplier tubes 19A-B should be sensitive to the wavelength associated with both the fast component and the slow component. In the case of sodium-doped cesium iodide, the fast component is in the UV range and the slow component is in the visible range. However, other dual-speed scintillation crystals may have different properties.

Another solution to avoid having to provide such photomultiplier tubes is to provide a wavelength shifting device, such as wavelength shifting fibers, to shift the wavelength of either the slow response or the fast response, or both, to a wavelength to which the photomultiplier tubes 19A-19B are sensitive.

The scintillator block 21 is divided into individual pillars 23, each of which is made of a dual-speed scintillating crystal. The pillars 23 are arranged in an array, for example a 10×16 array. The array has a rectangular cross-section with a length of 3.22 inches (82 millimeters) and a width of 2.69 inches (68 millimeters).

Each pillar 23 in the array is a rectangular prism having a transverse cross-section with a long side 25 and a short side 27. The axis parallel to the long side 25 will be referred to herein as the “major” axis of the scintillator block 21, and the axis parallel to the short side 27 of the will be referred to herein as the “minor” axis of the scintillator block 21.

To image a portion of a patient with a PET scanner 10, one introduces a radioactive material into the patient. As the radioactive material decays, it emits positrons. A positron, after traveling a short distance through the patient, eventually encounters an electron. The resulting annihilation of the positron and the electron generates two gamma ray photons traveling in opposite directions. To the extent that neither of these gamma ray photons is deflected or absorbed within the patient, they emerge from the patient and strike two opposed pillars 23, thereby generating a flash of light indicative of an event. By determining from which pillars 23 the light indicative of an event originated, one can estimate where in the patient the annihilation event occurred.

In particular, referring again to FIG. 1, when one of these gamma ray photons strikes a pillar in a first detector module 16A, the other gamma ray photon strikes a pillar in a second detector module 16E, F, G, or H opposed to the first detector module. This results in two events: one at the first detector module 16A and the other at the opposed second detector module 16E, F, G, or H. Each of these events indicates the detection of a gamma ray photon. If these two events are detected at the first detector module 16A and the second detector module 16E, F, G, or H at the same time, it is likely that they indicate an annihilation occurring on a line connecting first detector module 16A and the second detector module 16E, F, G, or H. If these two events are detected at the first detector module 16A and the second detector module 16E, F, G, or H at almost the same time, it is likely that they indicate an annihilation occurring on a line connecting first detector module 16A and the second detector module 16E, F, G, or H.

It is apparent that what is of interest in a PET scanner 10 are pairs of events detected by opposed detector modules 16A, 16E-F at, or almost at, the same time. A pair of events having these properties is referred to as a “coincidence.” In the course of a PET scan, each detector module 16A-K detects a large number of events. However, only a limited number of these events represent coincidences.

An important task of a PET scanner 10 is therefore to distinguish between those event pairs that form a coincidence and those that do not. Two metrics that are available for carrying out this task are: (1) the times at which the events occurred; and (2) the energies associated with each event.

Whether or not two events are indeed coincidences can be determined by observing the fast response to determine if the events occurred closely enough together in time, and the slow response to determine if the energies associated with the two events are consistent with the possibility that the two events arose from the same gamma ray interaction.

The fast response is particular useful for determining when an event occurred because its rapid rise time and narrow width enable one to more accurately estimate the precise time at which an event occurred. On the other hand, the extended duration and large number of photons associated with the slow response make it especially suitable for accurately estimating the energy associated with an event.

A dual-speed scintillation crystal is suitable for this task because such a crystal maintains distinct fast and slow responses.

In heavily-doped cesium iodide crystals, only the slow response is readily available. Such crystals are therefore not as useful for accurately determining when an event occurs. On the other hand, in intrinsic, or pure, cesium iodide, only the fast response is readily available. Such single-speed crystals are therefore less useful for accurately determining the energy associated with an event.

The methods and systems described herein have been described in the context of PET scanners. However, the use of dual-speed scintillation crystals is not limited to PET scanners. There are other fields in which one wishes to accurately determine both the time an event occurs and the energy associated with such an event. Many such application would benefit from the use of a dual-speed scintillation crystal as described herein. For example, such dual-speed scintillation crystals can be used for non-destructive testing devices, or for test equipment and laboratory equipment to be used in high-energy particle physics research.

The enhanced temporal resolution associated with the methods and systems described herein can also be used to perform time-of-flight analysis on photons detected at opposing photodetectors. Such time-of-flight analysis more easily enables one to estimate not only the line along which an event occurred but also the position of the event along that line.

Having described the invention, and a preferred embodiment thereof, what I claim as new, and secured by Letters Patent is:

1. An apparatus for detecting radiation, the apparatus comprising
a dual-speed scintillator for receiving the radiation and emitting secondary radiation in response thereto, and
detectors in communication with the dual-speed scintillator for receiving the secondary radiation.

2. The apparatus of claim 1, further comprising
a processor in communication with the detectors, the processor being configured to generate an image in response to signals received from the detectors.

3. The apparatus of claim 1, wherein the dual-speed scintillator comprises intrinsic cesium iodide.

4. The apparatus of claim 3, wherein the intrinsic cesium iodide has been heated and quenched to form lattice defects.

5. The apparatus of claim 1, wherein the dual-speed scintillator comprises sodium-doped cesium iodide.

6. The apparatus of claim 5, wherein the cesium iodide is doped with sodium at a concentration between 30 ppm and 200 ppm.

7. The apparatus of claim 5, wherein the cesium iodide is doped with sodium at a concentration of about 100 ppm.

8. The apparatus of claim 1, wherein the dual-speed scintillator comprises thallium-doped cesium iodide.

9. The apparatus of claim 1, wherein the dual-speed scintillator comprises cesium bromide.

10. The apparatus of claim 1, wherein the dual-speed scintillator comprises cesium iodide and cesium bromide.

11. The apparatus of claim 10, wherein the scintillator comprises approximately 2% bromine and 98% iodine.

12. The apparatus of claim 1, wherein the scintillation crystal comprises europium.

13. The apparatus of claim 1, wherein the dual-speed scintillator comprises doped cesium iodide.

14. A method for detecting radiation, the method comprising:
receiving first data representative of a slow component from a scintillator;
receiving second data representative of a fast component from a scintillator;
processing the first data to obtain an estimate of a first characteristic of an event within the scintillator; and
processing the second data to obtain an estimate of a second characteristic of an event within the scintillator.

15. The method of claim 14, further comprising classifying the event as one event of a coincidence at least in part on the basis of the first and second data.

16. The method of claim 14, further comprising selecting the first characteristic to be an energy associated with the event.

17. The method of claim 14, further comprising selecting the second characteristic to be a time of occurrence of the event.

18. The method of claim 14, further comprising estimating a time-of-flight associated with photons emitted as a result of the event.
